(19) United States
(12) Patent Application Publication
(10) Pub. No.: US 2019/0219971 A1
(43) Pub. Date: Jul. 18, 2019

(54) Roller-type electronic watch

(71) Applicant: Cai Fang LUO, Guangdong (CN)

(72) Inventor: Cai Fang LUO, Guangdong (CN)

(21) Appl. No.: 15/871,137

(22) Filed: Jan. 15, 2018

(51) Int. Cl. G04G 17/04; G04G 21/02; G04G 17/08; G04G 19/00

(52) U.S. Cl. CPC G04G 17/04; G04G 19/00; G04G 17/08; G04G 21/025

(57) ABSTRACT

This utility model provides a roller-type electronic watch comprising a watch body and a watch strap. The watch body includes a watch case, rollers, drive devices, a control circuit board and a battery. A character or pattern is set on the peripheral surfaces of the rollers. The control circuit board controls the drive devices to move. The drive devices drive the rollers to rotate, so that the peripheral surfaces of the rollers display information from the window of the watch case. The roller-type electronic watch of this utility model has a unique display manner and has special sporty feel.

### BACKGROUND OF THE INVENTION

This utility model relates to the technical field of electronic watch, especially to a roller-type electronic watch.

A watch is an important tool for people to watch the time and date. However, due to its single function without any specialty, more and more people choose not to wear a watch. Currently, the watch on the market is mainly classified into three types: mechanical watch, quartz watch and electronic watch, in which the electronic watch takes a minicell as the power source, generates vibration with a quartz crystal, performs frequency division with an electronic circuit, and displays time with a liquid crystal digital display, and is completely composed of an electronic circuit internally, and has no mechanical moving component. The existing liquid crystal digital display often has a limited viewing angle, and single appearance without specialty, and cannot meet the needs of people.

### BRIEF SUMMARY OF THE INVENTION

This utility model aims to provide a roller-type electronic watch that can efficiently overcome the above-mentioned problems, display information in a manner of rolling roller, and have special shape and sporty feel.

The aim of this utility model is realized by the following scheme: it comprises a watch body and a watch strap; the watch body includes a watch case, rollers, drive devices, a control circuit board and a battery, the watch case is provided with a window from which the rollers are exposed, a character or pattern is set on the peripheral surfaces of the rollers, the control circuit board is electrically connected with the battery, the drive devices are fixedly connected with the rollers, and the drive devices receive a control signal transmitted by the control circuit board and drive the rollers to rotate.

In the above-mentioned structure, the watch case comprises a front case, a rear case buckled with the front case and a dial, the dial is a disk type and is fixedly connected with the front case, and the window is opened on the dial.

In the above-mentioned structure, each drive device comprises a stepping motor and a gearbox disposed in the stepping motor.

In the above-mentioned structure, the axial direction of an output shaft of each drive device is parallel to the dial.

In the above-mentioned structure, the axial direction of the roller is parallel to the dial.

In the above-mentioned structure, the number of the rollers is one or multiple groups.

In the above-mentioned structure, the housing shape of the stepping motor is cylindrical, rectangular or special type.

In the above-mentioned structure, the character or pattern set on the peripheral surface is one or more of Arabic numerals, English or Chinese.

In the above-mentioned structure, the watch case comprises a front case and a rear case buckled with the front case, and the window is opened on the end of the front case; or

the watch case comprises a front case, a rear case buckled with the front case and a dial, the dial is fixedly connected with the front case, and the window is opened on the dial.

In the above-mentioned structure, information displayed on the peripheral surface is one or more of time, a temperature, a heart rate or an amount of exercise.

The roller-type electronic watch of this utility model differs from the traditional electronic watch in that it displays information in a manner of using a liquid crystal digital display or a watch hand, displays information of a roller in a manner in which the roller is driven to rotate by a motor, and has a unique display manner and special sporty feel.

### BRIEF DESCRIPTION OF THE DRAWINGS

This utility model is further described as follows in conjunction with the accompanying drawings.

FIG. 1 is an elevation structural schematic diagram of a roller-type electronic watch of this utility model;

FIG. 2 is an exploded structural schematic diagram of the roller-type electronic watch of this utility model;

FIG. 3 is an elevation structural schematic diagram of an embodiment of the roller-type electronic watch of this utility model.

In the figures: 100, watch body; 10, watch case; 11, window; 12, front case; 13, rear case; 14, dial; 20, roller; 21, peripheral surface; 30, drive device; 40, control circuit board; 41, IC chip; 50, battery; 60, button.

### DETAILED DESCRIPTION OF THE INVENTION

This utility model is further described as follows in conjunction with the accompanying drawings and the preferred embodiments:

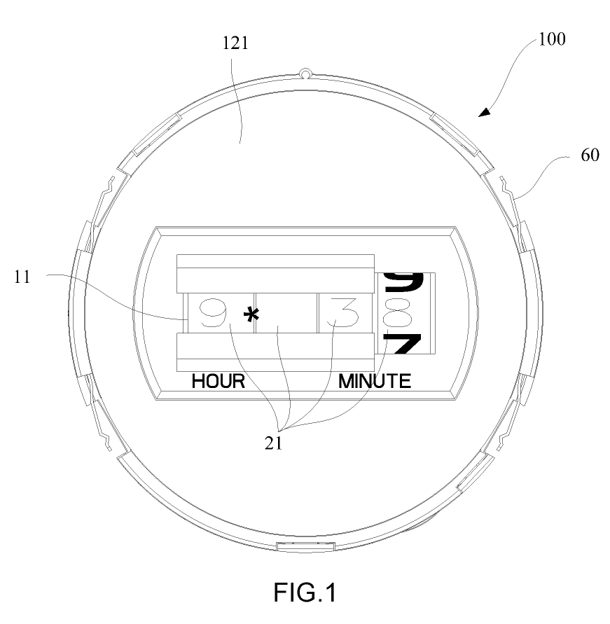

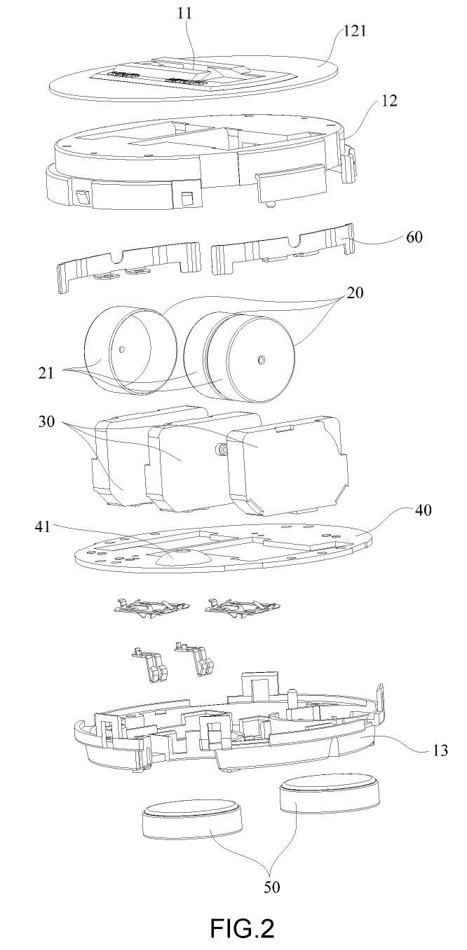

As shown in FIGS. 1-2, the roller-type electronic watch 20 of this utility model includes a watch body 100 and a watch strap (not shown). The watch body 100 includes a watch case 10, rollers 20, drive devices 30, a control circuit board 40 and a battery 50. In particular, the battery 50 in this embodiment is a button cell. The shape of the watch body 100 is not limited, and it can be a shape such as a flat cylinder or a rectangle, and is flat cylinder in this embodiment. The rollers 20 may be cylindrical or polygonal. The watch body 100 is provided with a button 60 used for adjusting. The rollers 20, the drive devices 30, the control circuit board 40 and the battery 50 are disposed in the watch case 10. The control circuit board 40 is fixedly connected with the watch case 10. The drive devices 30 are fixed on the control circuit board 40. The button 60 is disposed on the peripheral surface of the watch case. The watch case 10 is provided with a window 11 from which the peripheral surfaces 21 of the rollers 20 are exposed. A character or pattern is set on the peripheral surfaces 21 of the rollers 20. Information on the peripheral surfaces 21 may be embodied in a manner of printing, marking and the like, and is realized in a printing manner in this embodiment. The number of the drive devices 30 corresponds to that of the rollers 20. The drive devices 30 are disposed in the watch case 10 and are electrically connected with the control circuit board 40. The control circuit board 40 is electrically connected with the battery 50. The output shaft of each drive device 30 is fixedly connected with the rollers 20. In this embodiment, the drive devices 30 are micro stepping motors with a model number of 1015. The control circuit board 40 is provided with an IC (Integrated Circuit) chip 41. In particular, the model number of the IC chip 41 in this embodiment is LSK589. The IC chip 41 transmits a control signal to the drive devices 30. The drive devices 30 receive the control signal transmitted by the control circuit board 40 and drive the rollers 20 to rotate, so that information on the peripheral surfaces 21 of the rollers 20 is displayed from the window 11.

Further, the watch case 10 includes a front case 12, a rear case 13 buckled with the front case 12 and a dial 121. The dial 121 is a disk type and is fixedly connected with the front case 12. The window is opened on the dial 121. The dial 121 is a disk type and disposed on the end face of the front case 12. The front case 12 is fixedly connected with the dial 121. The dial 121 of the front case 12 provides information to be obtained for the user. The dial 121 is vertical to the axial direction of the cylindrical watch body 100.

Further, each drive device 30 includes a stepping motor and a gearbox disposed in the stepping motor. The stepping motor and the gearbox are integrally arranged, and may be in a state in which the gearbox is disposed in the stepping motor, or the stepping motor is disposed in the gearbox. In this embodiment, the manner in which the gearbox is disposed in the stepping motor is adopted.

Further, the axial direction of the output shaft of each drive device 30 is parallel to the dial 121. The drive devices 30 are vertically disposed on the control circuit board and are disposed vertical to the dial 121.

Further, the axial direction of the roller 20 is parallel to the dial 121. The rollers 20 are in a cylindrical or polygonal shape. The axial direction of each roller 20 is parallel to the dial 121. The end face of each roller 20 is disposed vertical to the dial 121.

Further, the number of the rollers 20 is one or multiple groups. In particular, the number of the rollers in this embodiment is multiple groups.

Further, the housing shape of the stepping motor is cylindrical, rectangular or special type. In particular, the housing shape of the stepping motor is rectangular in this embodiment. The stepping motor is disposed vertical to the dial 121.

Further, the character or pattern set on the peripheral surfaces 21 is one or more of Arabic numerals, English or Chinese.

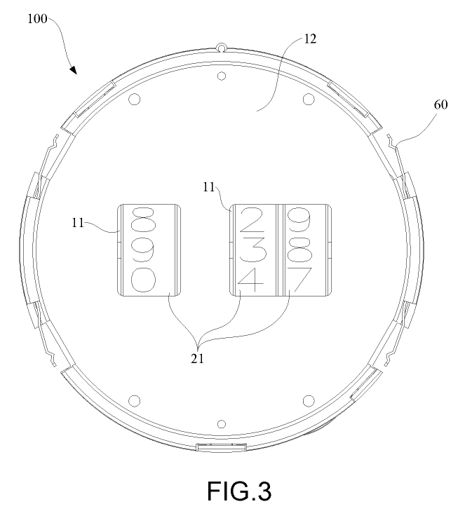

Further, the watch case 10 includes a front case 12 and a rear case 13 buckled with the front case 12. The window 11 is opened on the end of the front case 12. The display state of the window 11 is shown in FIG. 3, in which the area of the rollers 20 exposed from the window 11 is larger to display more complex information. Alternatively, the watch case 10 includes a front case 12, a rear case 13 buckled with the front case 12 and a dial 121. The dial 121 is fixedly connected with the front case 12. The window 11 is opened on the dial 121. The display state of the window 11 is shown in FIG. 1. The window 11 is configured such that people obtain information more efficiently.

Further, information displayed on the peripheral surfaces 21 is one or more of time, a temperature, a heart rate or an amount of exercise. The roller peripheral surfaces 21 may be further used for displaying information such as date, week, blood pressure and the like.

The above is only a preferred embodiment of this patent, but doesn't limit the scope of this patent. An equivalent structure or flow transformation made by using the Specification and the content of the accompanying drawings is applied to other related technical fields directly or indirectly, which belongs to the protection scope of this patent.

1: A roller-type electronic watch, comprising a watch body and a watch strap, wherein the watch body includes a watch case, rollers, drive devices, a control circuit board and a battery, the watch case is provided with a window from which the rollers are exposed, each changeable character or pattern of information displayed by the roller-type electronic watch is changeable due to rotation of a corresponding roller having characters or patterns printed on a peripheral surface thereof, the control circuit board is electrically connected with the battery, the drive devices are fixedly connected with the rollers, and the drive devices receive a control signal transmitted by the control circuit board and drive the rollers to rotate.

2: The roller-type electronic watch of claim 1, characterized in that the watch case comprises a front case, a rear case buckled with the front case and a dial, the dial is a disk type and is fixedly connected with the front case, and the window is opened on the dial.

3: The roller-type electronic watch of claim 2, characterized in that each drive device comprises a stepping motor.

4: The roller-type electronic watch of claim 3, characterized in that the axial direction of an output shaft of each drive device is parallel to the dial.

5: The roller-type electronic watch of claim 4, characterized in that the axial direction of each roller is parallel to the dial.

6: The roller-type electronic watch of claims 1-5, characterized in that a number of the rollers is one or multiple groups.

7: The roller-type electronic watch of claim 3, characterized in that a housing shape of the stepping motor is cylindrical, rectangular or special type.

8: The roller-type electronic watch of claim 7, characterized in that the character or pattern is one or more of Arabic numerals, English or Chinese.

9: The roller-type electronic watch of claim 1, characterized in that the watch case comprises a front case and a rear case buckled with the front case, and the window is opened on the end of the front case; or
the watch case comprises a front case, a rear case buckled with the front case and a dial, the dial is fixedly connected with the front case, and the window is opened on the dial.

10: The roller-type electronic watch of claim 9, characterized in that the information displayed is one or more of time, a temperature, a heart rate or an amount of exercise.
